(19) United States
(12) Patent Application Publication
(10) Pub. No.: US 2002/0057871 A1
(43) Pub. Date: May 16, 2002

(54) Method for aligning optical components

(76) Inventors: William Trimmer, Belle Mead, NJ (US); Glenn Fricano, Islip, NY (US)

Correspondence Address: Marc Kaufman, Esquire, Nixon Peabody LLP, Suite 800, 8180 Greensboro Drive, McLean, VA, 22102, US

(21) Appl. No.: 09/843,274

(22) Filed: Apr. 25, 2001

Related U.S. Application Data
(60) Provisional application No. 60/199,739, filed on Apr. 25, 2000.

(51) Int. Cl. G02B 6/26; G02B 6/32

(52) U.S. Cl. 385/31; 385/34

(57) ABSTRACT

In a fiber optic system, a method for aligning an incoming beam of light and a target fiber that does not use light travelling down the core of the fiber to make adjustments to the relative positions of the beam of light and the fiber. According to the method of the invention, cladding mounted light detectors detect light in the cladding as the beam of light sweeps across the fiber, and a minimum amount of light detected in the cladding is established during the course of the sweeps. The relative positions of the beam of light and the fiber are then adjusted so that the light detected in the cladding corresponds to the minimum detected during the sweeps.

### FIELD OF THE INVENTION

This invention relates to fiber optic systems, and in particular to the alignment of optical components and devices such as optical waveguides or fibers, in order to achieve high coupling efficiency of the optical components.

### BACKGROUND OF THE INVENTION

Communication systems employing optical fibers are commonly used for high data rate telecommunications. Optical fibers are thin strands of glass capable of transmitting optical signals containing large amounts of information over long distances with very low loss. In essence, an optical fiber is a small diameter waveguide comprising a core having a first index of refraction surrounded by a cladding having a second (lower) index of refraction. Typical optical fibers are made of high purity silica with minor concentrations of dopants to control the index of refraction. Optical fibers are typically coupled with a gradient refractive index (GRIN) lens having a refractive index that varies along a radial axis of the light transceiving end of the device and/or along a longitudinal axis of the light transceiving end of the device.

Connectors are important components in optical fiber systems. It is highly desirable to provide efficient optical coupling between optical fibers or between optical fibers and other optical components and devices in an optical communications system. In particular, optical components such as laser diodes, optical switches, modulators, wavelength selecting devices and the like are optically coupled together by optical fibers. The precision alignment of optical paths, either permanent or reconfigurable, between two mating devices is essential for maximum optical coupling efficiency. For example, in the interconnection of a single mode optical fiber, the alignment tolerance must be on the order of a few microns or less. The extremely small diameter of the optical fibers used for optical communications, which is on the order of 125 microns in outer diameter with a typical core diameter of 8 microns, makes mechanical alignment of the fiber core with other optical components difficult. Since a desirable quality of an optical data transmission system is to transmit light energy with minimal loss and distortion, attempts have been made in the prior art to provide a means for aligning optical components without suffering deleterious effects. The coupling or interconnection of optical fiber to optical fiber or optical fiber to optical device can be complicated by a mismatch-between the numerical apertures of the optical fibers and/or the optical device(s).

FIG. 1 shows an overview of a representative fiber optic interconnection system of the prior art having an array of input fibers 1 and an array of output fibers 3. Light 5 from the fiber optical elements pass through a transparent plate 7, optionally made of glass, or optionally a plate with appropriate openings. Light from the fiber element passes through the plate, strikes one mirror 9, which may be caused to rotate or tilt about one axis, passes through the plate again, strikes a second mirror 11, which may be caused to rotate or tilt about a second axis, passes through the plate a third time, and continues in the direction of the output fiber array 3. The ability of these two mirrors to move in two different axes, respectively, allows the beam to be steered in two axes. The mirrors in front of both the input and output fibers must be aligned correctly to successfully transmit the light from one fiber to the other.

FIG. 2 shows the transmission of a single beam of light 13 from one of the input fibers 1c to a selected output fiber 3f using mirrors 9c, 11c, 15f & 17f and guided by beam sensors 19 located between each output fiber. As the input fiber mirrors 9c & 11c scan the beam 13 across the output fibers 3a-3g, these beam sensors 19 measure how far the beam 13 has traveled across the region of the output fibers. This allows the input fiber mirrors 9c & 11c to be rapidly brought into approximate alignment with the output fiber mirrors 15f & 17f. Now the output fiber mirrors 15f & 17f are adjusted to bring the light into the range of the GRIN lens and output fiber.

Once the mirrors are aligned so the beam of light is focused between the beam sensors flanking the selected output fiber, the amount of light travelling down the core 31 is measured using core receptors 21 (see FIG. 3), and fine adjustments are made to the mirrors and/or to the fiber to maximize the light received by the core receptors 21. When no light is detected in the core 31, cladding mounted light detectors 23 have been used to direct the beam to the core. Once light is detected in the core, the core receptors are used to conduct the fine tuning of the beam 13 and the fiber 3f relative to one-another to maximize the light in the core.

### SUMMARY OF THE INVENTION

The inventors of the present invention discovered that using light travelling down the core to align optic fibers is less efficient than using light detected in the cladding as a primary and/or sole method of fine or final alignment of optic fibers. Accordingly, the present invention is a method for aligning optical fibers and devices that does not rely on optical receivers that detect light travelling down the central core. Instead, the present invention is a method for aligning optical fibers and devices by detecting light in the outer cladding of an optical fiber using a so-called cladding detector. According to this method, the alignment of fibers and/or devices is adjusted until the light detected by the cladding detector reaches a minimum.

According to one embodiment, a single cladding detector may be used at between about 0.5 mm to about 4 mm from the end of the optic fiber, where any light entering the cladding has been sufficiently diffused to the point that it has little or no directional component. According to this embodiment, the incoming beam of light is caused to sweep back and forth across the face of the fiber in one, two or three dimensions as alignment takes place, and the fiber is determined to be aligned when the light detected by the cladding detector goes to a minimum.

According to another embodiment, multiple cladding detectors may be used at or near the face of the fiber where any light received into the cladding has not been sufficiently diffused to avoid detection of its direction of origin. According to this embodiment, the amount of light being detected by each of the multiple cladding detectors may be used to align the fiber in a coordinated fashion. While according to this invention, use of cladding detectors is considered to be the primary method of aligning optical fibers, it is contemplated that use of core detectors may be used as an auxiliary and/or periodic check of alignment. The use of cladding detectors to the exclusion of core detectors is also considered to be part of the present invention.

According to one embodiment of the invention, there is provided a method for aligning a beam of light and an optical fiber, the optical fiber having a central core and a cladding, wherein a beam of light is directed toward an optical fiber, light in the cladding of the optical fiber is detected, and the relative orientation of the beam of light and the optical fiber are adjusted until the light detected in the cladding reaches a minimum.

According to a further embodiment of the invention, a minimum of light detected by the cladding detector is determined as the beam of light scans across the fiber. Specifically, according to this embodiment, the beam of light is swept across the face of the optical fiber and the amount of light detected by the cladding detector is monitored as the beam of light sweeps across the face of the fiber, and the smallest value corresponding to light detected by said cladding detector during said sweeps is selected as the minimum. According to a preferred embodiment of the invention, the minimum amount of light detected during the sweeps is zero, or otherwise corresponds to no light being detected in the cladding.

According to a preferred embodiment, use of the cladding detectors is the sole method of fine tuning the orientiation of the beam and the fiber, and the light travelling down the core is not used to make adjustments to the fiber and/or to the beam of light.

According to yet another preferred embodiment, the beam of light sweeps across the fiber in two axes, at two different frequencies, and the amount of light detected in the cladding detector is filtered according to the two frequencies to compute necessary adjustments to the beam and/or to the fiber. According to a further preferred embodiment, multiple cladding detectors are used around the circumference of the fiber, and the adjustments to the beam are made based on which detectors are detecting light, and how much light each detector is detecting.

### BRIEF DESCRIPTION OF THE FIGURES

FIG. 1 is a representation of a fiber optic interconnection of the prior art having arrays of input and output fibers.

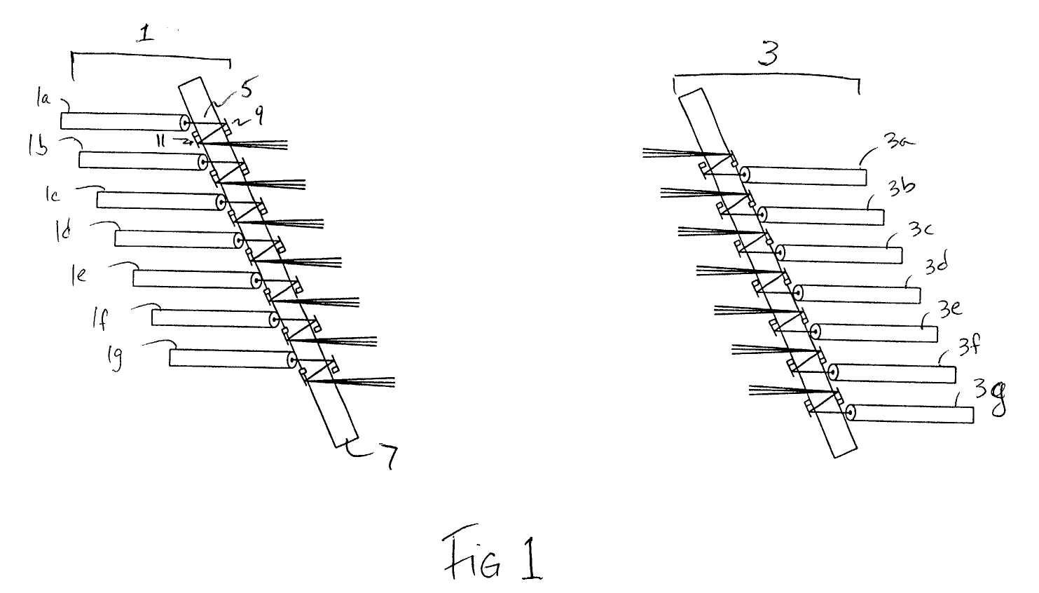

FIG. 2 is a representation of the fiber optic interconnection of FIG. 1 showing the transmission of a single beam of light from one input fiber to one output fiber using the pairs of mirrors adjacent to each fiber.

FIG. 3 is a double close-up of one output fiber according to the invention showing a GRIN lens, cladding detector 23 and alternative multiple cladding detectors 25a-25d.

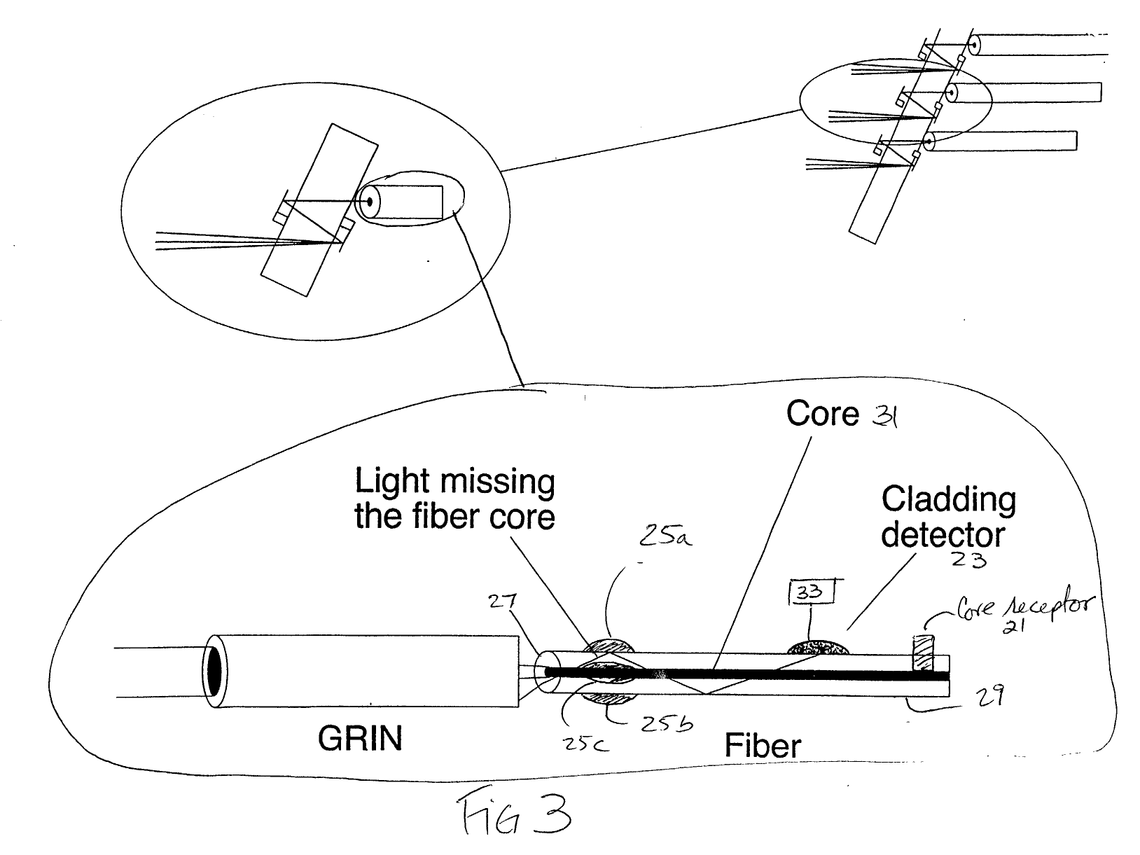

### DESCRIPTION OF THE PREFERRED EMBODIMENTS OF THE INVENTION

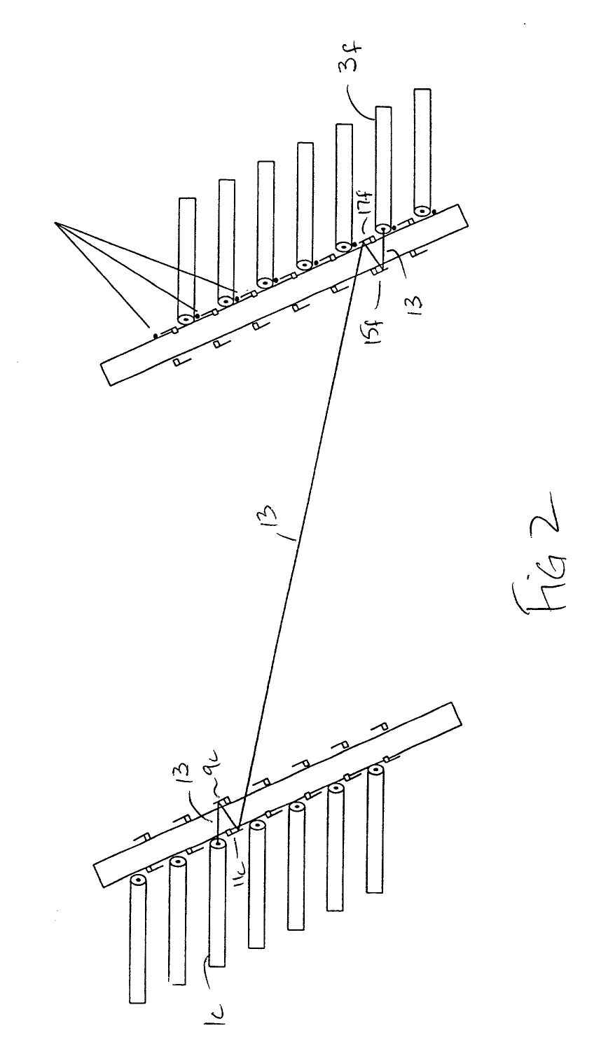

Referring to FIG. 2, input fiber 1c transmits a beam of light 13 from its end through a GRIN lens (not shown). Mirrors 9c and 11c direct the beam 13 to an array of output fibers 3. As the beam 13 sweeps across the array of output fibers 3, beam sensors 19 guide the beam 13 to a selected output fiber 3f. According to a preferred embodiment, beam sensors flanking each output fiber are close enough together so that when the beam is between two beam sensors, it must contact the output fiber between them. Once the beam is contacting the selected output fiber, cladding detector 23 detects light in the cladding 29.

The beam 13 is caused to sweep across the fiber 3f, and the fluctuations in the light detected by the cladding detector are monitored, and a minimum value of light detected during said sweeps is established. The relative position of the incoming beam 13 and the fiber 3f are adjusted so that the amount of light detected by the cladding detector 23 equals the established minimum. Preferably, the minimum corresponds to no light being detected by the cladding detector 23. Optionally, the amount of light travelling down the core 31 may be sampled. However, according to a preferred embodiment of the invention, alignment of the beam is accomplished without sampling any light travelling down the core of the fiber.

According to the embodiment described above, the beam can be caused to scan across the surface of the fiber in a first axis at one predetermined frequency, and to scan across the surface of the fiber in a second axis at a second predetermined frequency. The cladding detector, or a microprocessor 33 associated with the cladding detector, may then filter the input by frequency and thereby determine the direction in which the beam and/or fiber needs to be adjusted to ensure optimal alignment.

According to an alternative embodiment, multiple cladding detectors 25a-25d (25d is hidden) are situated on the cladding 29, preferably between 0 mm and about 0.5 mm from the receiving end 27 of the fiber. According to this embodiment, the cladding detectors 25a-25d are situated sufficiently close to the end 27 of the fiber that the point at which the beam contacts the cladding 29 is still susceptible to determination, i.e., before any light contacting the cladding is completely diffused throughout the cladding. According to this embodiment, the relative orientation of the incoming beam of light 13 and the fiber may be adjusted according to which cladding detectors are detecting light and/or how much light each cladding detector is detecting.

What is claimed is:

1. In a fiber optic system, a method for aligning a beam of light and an optical fiber comprising
a central core and a cladding, comprising the steps:
directing said beam of light toward said optical fiber,
detecting light in the cladding of said optical fiber;
adjusting the relative orientation of said beam of light and said optical fiber until said light detected in said cladding reaches a minimum.

2. A method according to claim 1 further comprising determining a minimum

3. A method according to claim 2 wherein said determining a minimum step comprises:
sweeping said beam of light across a face of said optical fiber,
monitoring the amount of light detected by said cladding detector as said beam of light sweeps across said face, and
selecting a smallest value corresponding to light detected by said cladding detector during said sweeps.

4. A method according to claim 1 wherein said minimum corresponds to no light being detected in said cladding.

5. A method according to claim 1 wherein light travelling down the core of said fiber is not measured in connection with said adjusting step.

6. A method according to claim 1 wherein said beam of light is caused to move in a first axis at a first frequency and in a second axis at a second frequency, and the amount of light detected in said cladding is filtered according to said frequencies.

7. A method according to claim 1 comprising detecting light in said cladding from a plurality of locations around a circumference of said fiber.
